(19) United States
(12) Patent Application Publication
(10) Pub. No.: US 2012/0180227 A1
(43) Pub. Date: Jul. 19, 2012

(54) WASHING MACHINE AND METHOD FOR CONTROLLING THE SAME

(75) Inventors: Hyun Sook KIM, Hwaseong-si (KR); Eun Suk Bang, Hwaseong-si (KR)

(73) Assignee: Samsung Electronics Co.,Ltd., Suwon-si (KR)

(21) Appl. No.: 13/337,825

(22) Filed: Dec. 27, 2011

(30) Foreign Application Priority Data
Jan. 17, 2011 (KR) 10-2011-0004557

(51) Int. Cl. G06F 1/32; D06L 1/00

(52) U.S. Cl. 8/137

(57) ABSTRACT

A washing mode set by a user is changed to a washing mode having a low energy cost and washing effect corresponding to the washing effect of the user-set washing mode, and a washing operation is performed in the changed washing mode. Details of the washing mode change and energy cost change according thereto are displayed on a display such that a user confirms them and determines whether or not to select a washing mode having lower energy cost. Upon completion of the washing operation, an energy cost reduction result is displayed on the display such that the user can directly confirm energy reduction effect, thereby remarkably improving the reliability of the washing machine.

### CROSS-REFERENCE TO RELATED APPLICATIONS

This application claims the benefit of Korean Patent Application No. 10-2011-0004557, filed on Jan. 17, 2011 in the Korean Intellectual Property Office, the disclosure of which is incorporated herein by reference.

### BACKGROUND

1. Field

Embodiments of the present disclosure relate to a washing machine, and more particularly, to management of power consumption of a washing machine.

2. Description of the Related Art

Conventional washing machines or drying machines employ an algorithm that drives a heater to perform a washing or drying operation at a predetermined temperature or uses external hot water for washing. The washing machines or drying machines consume high instantaneous power because they use a heater and consume a large amount of electric power if the heater is used for a long time. As energy saving has become important recently, a system in which a power provider charges energy cost for each time period in response to energy demand state is provided. However, conventional washing machine/drying machine control methods are not able to handle energy cost variation.

### SUMMARY

Therefore, it is an aspect of the present disclosure to provide a washing machine and a method for controlling the same to change a washing mode set by a user to a washing mode which has a low energy cost while providing washing effect corresponding to the washing mode set by the user and perform a washing operation in the changed washing mode, to thereby reduce energy costs generated during the washing operation.

It is another aspect of the present disclosure to provide a washing machine and a method for controlling the same to change a washing mode set by a user to a washing mode which has a low energy cost while providing washing effect corresponding to the washing mode set by the user, perform a washing operation in the changed washing mode, and display details about washing mode change and energy cost variation due to the washing mode change on a display such that a user can confirm details thereof and select whether or not to adopt the washing mode having a low energy cost.

It is another aspect of the present disclosure to provide a washing machine and a method for controlling the same to change a washing mode set by a user to a washing mode which has a low energy cost while providing washing effect corresponding to the washing mode set by the user, perform a washing operation in the changed washing mode, display details about washing mode change and energy cost variation due to the washing mode change on a display such that a user can confirm the details and select whether or not to adopt the washing mode having a low energy cost, and display an energy cost reduction result on the display upon completion of the washing operation such that the user can directly confirm energy reduction effects.

Additional aspects of the disclosure will be set forth in part in the description which follows and, in part, will be apparent from the description, or may be learned by practice of the disclosure.

In accordance with one aspect of the present disclosure, a method for controlling a washing machine includes: inputting a washing mode by a user; replacing at least one of a plurality of unit cycles constructing the input washing mode with a new unit cycle having lower energy cost and washing effect similar to the washing effect of the input washing mode; displaying washing operation conditions of a changed washing mode including the new unit cycle on a display; and performing a washing operation in the changed washing mode displayed on the display.

The replacing of the at least one unit cycle with the new unit cycle may be performed in response to a washing mode change request for energy cost reduction.

The replacing of the at least one unit cycle with the new unit cycle may be selectively performed depending on energy costs of currently provided power.

The replacing of the at least one unit cycle with the new unit cycle may be performed when a difference between the input washing mode and the changed washing mode exceeds a predetermined reference value.

The method may further include confirming whether or not the user approves the washing operation conditions of the changed washing mode displayed on the display, and performing a washing operation in the changed washing mode when the user approves the washing operation conditions of the changed washing mode.

The method may further include displaying washing operation conditions of a washing mode prior to being changed on the display.

The method may further include displaying an energy cost status level of the washing mode prior to being changed on the display.

The method may further include displaying an energy cost estimate value of the washing mode prior to being changed and an energy cost estimate value of the changed washing mode on the display.

A washing operation may be performed in the changed washing mode when the user approves contents displayed on the display.

The method may further include receiving current energy cost information from an energy service provider, and calculating energy costs with reference to the received energy cost information.

In accordance with another aspect of the present disclosure, a method for controlling a washing machine includes: inputting a washing mode by a user; calculating energy cost of each of a plurality of unit cycles constructing the input washing mode with reference to a predetermined energy cost table; replacing at least one of the plurality of unit cycles with a new unit cycle having lower energy cost and washing effect similar to the washing effect of the input washing mode; and performing a washing operation in a changed washing mode if washing operation conditions of the changed washing mode is approved.

The replacing of the at least one unit cycle with the new unit cycle may be performed in response to a washing mode change request for energy cost reduction.

The replacing of the at least one unit cycle with the new unit cycle may be selectively performed depending on energy costs of currently provided power.

The replacing of the at least one unit cycle with the new unit cycle may be performed when a difference between the input washing mode and the changed washing mode exceeds a predetermined reference value.

The method may further include displaying the washing operation conditions of the changed washing mode including the new unit cycle on a display such that the user confirms the washing operation conditions of the changed washing mode, displayed on the display.

The energy cost table may represent correlation of energy cost and washing effect of each of unit cycles constructing a washing operation as data.

A unit cycle having higher energy cost among the plurality of unit cycles may be preferentially replaced with a new unit cycle having lower energy cost and similar washing effect.

Only unit cycle having energy cost higher than a predetermined value may be replaced with the new unit cycle.

In accordance with another aspect of the present disclosure, a method for controlling a washing machine includes: inputting a washing mode by a user; replacing at least one of a plurality of unit cycles constructing the input washing mode with a new unit cycle having lower energy cost and washing effect similar to the washing effect of the input washing mode; displaying washing operation conditions of a changed washing mode including the new unit cycle on a display; and performing a washing operation in the changed washing mode when the washing operation conditions of the changed washing mode, displayed on the display, are approved, wherein a total energy cost of the changed washing mode including the new unit cycle does not exceed a predetermined value.

In accordance with another aspect of the present disclosure, a method for controlling a washing machine includes: inputting a washing mode by a user; replacing at least one of a plurality of unit cycles constructing the input washing mode with a new unit cycle having lower energy cost and washing effect similar to the washing effect of the input washing mode; displaying washing operation conditions of a changed washing mode including the new unit cycle on a display; performing a washing operation in the changed washing mode when the washing operation conditions of the changed washing mode, displayed on the display, are approved; and displaying a degree of energy cost reduction, obtained from the washing operation performed in the changed washing mode, on the display upon completion of the washing operation in the changed washing mode.

In accordance with another aspect of the present disclosure, a method for controlling energy cost reduction of a washing machine includes: inputting a washing mode by a user; replacing at least one of a plurality of unit cycles constructing the input washing mode with a new unit cycle having lower energy cost and washing effect similar to the washing effect of the input washing mode; and performing a washing operation in a changed washing mode including the new unit cycle.

In accordance with another aspect of the present disclosure, a washing machine includes: a control panel by which a user inputs a washing mode; a display to display washing operation conditions of the input washing mode; and a controller to replace at least one of a plurality of unit cycles constructing the input washing mode with a new unit cycle having lower energy cost and washing effect similar to the washing effect of the input washing mode, to display washing operation conditions of a changed washing mode including the new unit cycle on the display, and to control a washing operation in the changed washing mode when the washing operation conditions of the changed washing mode, displayed on the display, are approved.

The controller may replace the at least one unit cycle with the new unit cycle in response to a washing mode change request for energy cost reduction.

The controller may selectively replace the at least one unit cycle with the new unit cycle depending on energy cost of currently provided power.

The controller may replace the at least one unit cycle with the new unit cycle when a difference between the input washing mode and the changed washing mode exceeds a predetermined reference value.

The controller may control the display to display the washing operation conditions of the changed washing mode.

The controller may control the display to display an energy cost status level of a washing mode prior to being changed.

The controller may control the display to display an energy cost estimate value of the washing mode prior to being changed and an energy cost estimate value of the changed washing mode.

The controller may perform a washing operation in the changed washing mode when user approves contents displayed on the display.

The controller may receive current energy cost information from an energy service provider, and calculate energy costs with reference to the received energy cost information.

The washing machine may further include an indicator lamp turned on when a washing operation is performed in the changed washing mode.

In accordance with another aspect of the present disclosure, a method for controlling energy cost reduction of a washing machine includes: calculating energy cost of each of a plurality of unit cycles constructing at least one washing mode; determining a substitute unit cycle having lower energy cost for each of the plurality of unit cycles; inputting a washing mode by a user; replacing at least one of a plurality of unit cycles constructing the input washing mode with the substitute unit cycle having lower energy cost; and performing a washing operation in a changed washing mode including the substitute unit cycle.

The energy cost may be energy cost per unit time.

According to one aspect of the present disclosure, a washing mode set by a user is changed to a washing mode which has lower energy cost while providing washing effect corresponding to the user-set washing mode and a washing operation is performed in the changed washing mode, to thereby reduce energy costs generated when the washing operation is carried out.

According to another aspect of the present disclosure, a washing mode set by a user is changed to a washing mode which has a low energy cost while providing washing effect corresponding to the washing mode set by the user, a washing operation is performed in the changed washing mode, and details about washing mode change and energy cost variation due to the washing mode change are displayed on a display such that a user can confirm details thereof and select whether or not to adopt the washing mode having a low energy cost to strongly reflect the user's intention in control of the washing machine.

According to another aspect of the present disclosure, a washing mode set by a user is changed to a washing mode which has a low energy cost while providing washing effect corresponding to the washing mode set by the user, a washing operation is performed in the changed washing mode, details about washing mode change and energy cost variation due to the washing mode change are displayed on a display such that a user can confirm the details and select whether or not to adopt the washing mode having a low energy cost, and an energy cost reduction result is displayed on the display upon completion of the washing operation such that the user can directly confirm energy reduction effects, to thereby remarkably improve the reliability of the washing machine.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows a washing machine according to an embodiment of the present disclosure;

FIG. 2 shows a configuration of a control panel and a display of the washing machine shown in FIG. 1;

FIG. 3 shows a power management system that is the basis of DR washing control of the washing machine shown in FIG. 1;

FIG. 4 shows a control system of the washing machine shown in FIG. 1;

FIG. 5 is a flowchart illustrating a method for controlling a washing machine according to an embodiment of the present disclosure;

FIG. 6 is a flowchart illustrating a method for controlling a washing machine according to another embodiment of the present disclosure;

FIG. 7 shows details displayed on a display when a DR selection key is pressed in a washing machine according to another embodiment of the present disclosure; and

FIG. 8 is a flowchart illustrating a method for controlling a washing machine according to another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

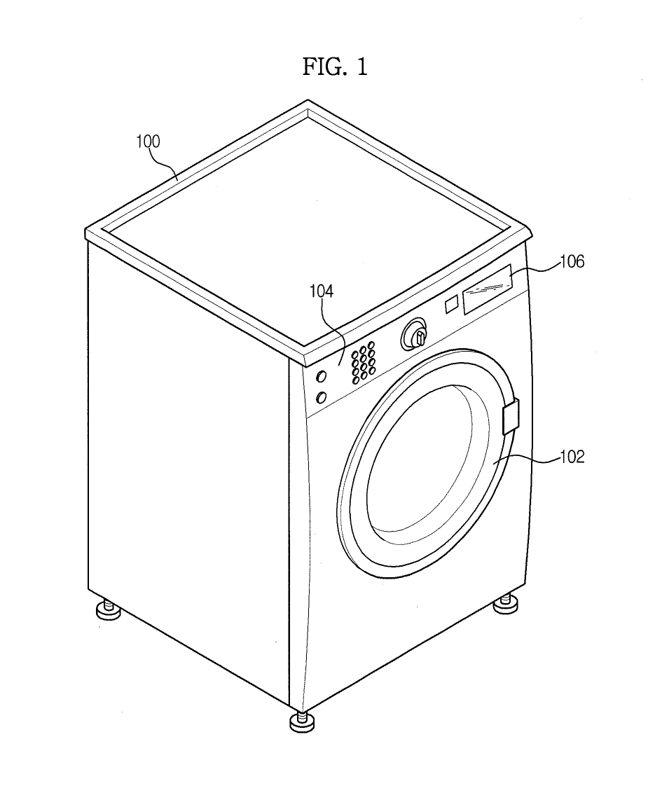

Embodiments of the present disclosure are explained with reference to FIGS. 1 to 8. FIG. 1 shows a washing machine according to an embodiment of the present disclosure. Referring to FIG. 1, a door 102 is provided to the front side of a washing machine body 100, and laundry is put into a drum (not shown) inside the washing machine or taken out of the drum through the door 102. A control panel 104 corresponding to an input unit and a display 106 corresponding to a display unit are arranged above the door 102 provided to the front side of the washing machine body 100. The control panel 104 is used for a user to input (set) a washing mode or a washing condition, and the display 106 displays the washing mode or washing condition input by the user, or an operating state (for example, a currently performed cycle, a degree to which the cycle is performed, the remaining operation time, etc.) of the washing machine during an operation of the washing machine such that the user can confirm the same.

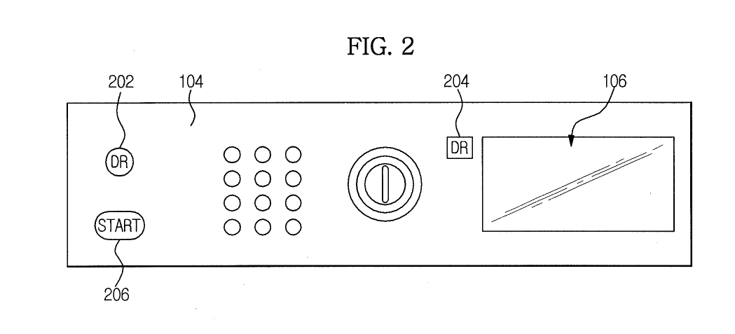

FIG. 2 shows a configuration of the control panel 104 and display 106 of the washing machines shown in FIG. 1. Referring to FIG. 2, the control panel 104 of the washing machine according to an embodiment of the present disclosure includes keys for inputting a washing mode or a washing condition, a DR selection key 202, and a washing start key 206. The user requests washing mode change for energy consumption reduction using the DR selection key 202. Here, DR represents Demand Response, and terms such as the DR selection key 202 and DR washing mode reflect the intention of the present disclosure to control a washing operation of the washing machine for the purpose of decreasing energy costs in consideration of a variation in a rate of power provided to a home according to time. In other words, the DR washing mode according to an embodiment of the present disclosure is a changed washing mode including a new unit cycle having a low energy cost and similar washing effect, which is a substitute for at least one unit cycle of a plurality of unit cycles constructing a washing mode input by the user. The washing start key 206 is used to start a washing operation corresponding to a currently set washing mode.

A DR indicator lamp 204 is turned on when the user selects the DR washing mode by pressing the DR selection key 202 or when the DR washing mode is executed. The user can recognize selection of the DR washing mode or execution of the DR washing mode with the naked eye through the DR indicator lamp 204.

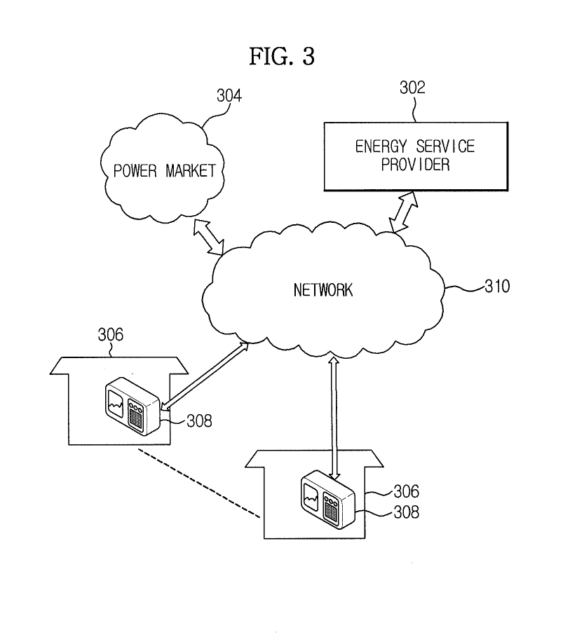

FIG. 3 shows a power management system 300 that is the basis of DR washing control of the washing machine shown in FIG. 1. Referring to FIG. 3, the power management system 300 includes an energy service provider 302, a power market 304, a power consumer 306, and a network 310. The energy service provider 302 generates electric power. The energy service provider 302 may distribute the generated electric power. Accordingly, the energy service provider 302 provides power to the power consumer 306 directly or indirectly. The power consumer 306 is provided with power from the energy service provider 302 according to a predetermined price policy and consumes the power. The washing machine according to the embodiment of the present disclosure corresponds to the power consumer 306.

The power consumer 306 includes a home power demand management apparatus 308. The energy service provider 302, power market 304 and power consumer 306 are connected through the network 310 such that they can exchange information about power demand management. The network 310 which links the energy service provider 302, power market 304 and power consumer 306 may be a wired network, wireless network, wired and wireless hybrid network, etc.

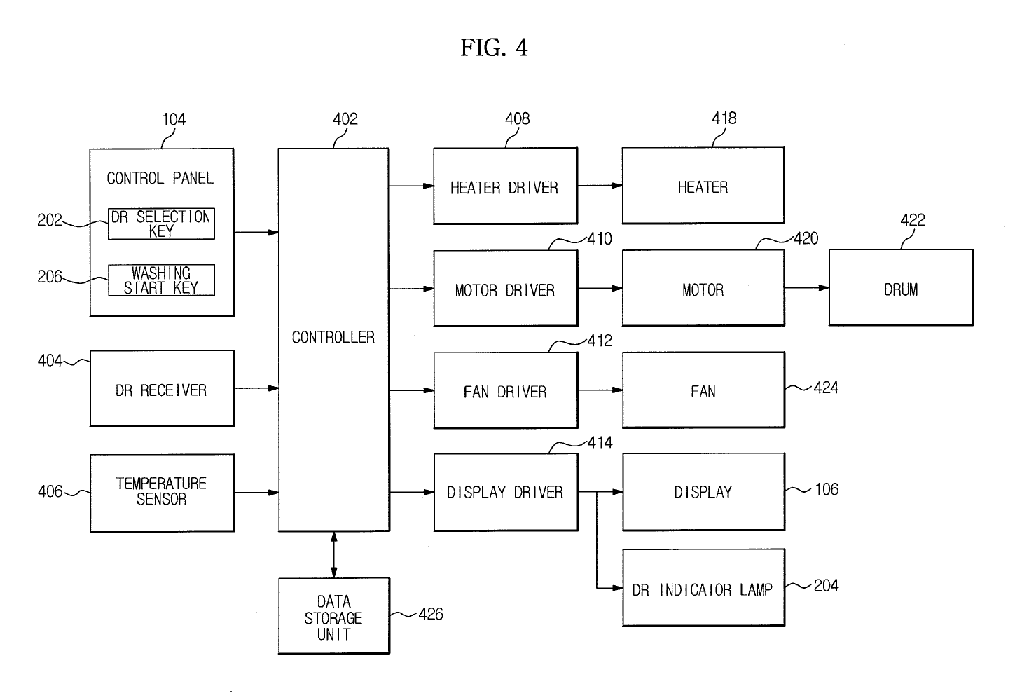

The power demand management apparatus 308 receives information about the rate of power currently provided from the energy service provider 302 and provides the information to a DR receiver (which will be explained below with reference to FIG. 4) of the washing machine according to the current embodiment of the present disclosure. The DR receiver of the washing machine receives the information and provides the information to a controller (which will be explained below with reference to FIG. 4) of the washing machine such that the controller of the washing machine can control a washing operation in consideration of energy cost reduction.

FIG. 4 shows a control system of the washing machine shown in FIG. 1. As shown in FIG. 4, the control panel 104 corresponding to an input unit, the DR receiver 404 and a temperature sensor 406 are connected to an input side of the controller 402 which controls the overall operation of the washing machine. The control panel 104 has been described above with reference to FIGS. 1 and 2. As described above with reference to FIG. 3, the DR receiver 404 receives cost information of currently provided energy (that is, information about a rate of currently provided power) from the energy service provider 302 through the power demand management apparatus 308 and provides the information to the controller 402. The temperature sensor 406 includes individual sensing units for measuring the internal temperature of the washing machine during a laundry drying operation and the temperature of hot water during a washing operation using the hot water, respectively. If one temperature sensor can measure two temperatures, the washing machine may include only one temperature sensor.

A heater driver 408, a motor driver 410, a fan driver 412, and a display driver 414 are connected to an output side of the controller 402 in such a manner that they can communicate with the controller 402. The heater driver 408 drives a heater 418 so as to heat the air or water. A heater for heating the air and a heater for heating water are separately provided. If the air and water can be heated using one heater, the washing machine may include only one heater. The motor driver 410 drives a motor 420 so as to rotate a drum 422. The fan driver 412 drives a fan 424 to provide heated air to the inside of the drum 422. The heated air supplied to the inside of the drum 422 is mostly used to dry washed laundry. The display driver 416 drives the display 106 to display information on the display 106 and turns on the DR indicator lamp 204.

Furthermore, a data storage unit 426 is connected to the controller 204 such that they can communicate with each other. The data storage unit 426 stores software (or firmware) required for the controller 402 to control the overall operation of the washing machine, data, etc. Particularly, the data storage unit 426 includes an energy cost table. The energy cost table represents correlation of energy costs and washing effects of unit cycles constructing a washing operation as data. Specifically, the energy costs and washing effects of the respective unit cycles are obtained through experimentation, and one unit cycle and a new unit cycle having a washing effect similar to that of the unit cycle and energy cost lower than that of the unit cycle are set such that the two unit cycles have a correlation. By doing so, the unit cycle can be replaced by the new unit cycle with reference to the correlation when washing mode change is requested to reduce energy costs. For example, while data about power consumption amounts according to use of the heater 418 is obtained in advance, a cycle (hot-water washing, drying cycle, etc.) using the heater 418 can be replaced by an energy reduction substitute cycle which requires a reduced temperature and increased operating time. In addition, a high-speed dehydrating cycle can be replaced by a middle-speed or low-speed dehydrating cycle having an increased dehydrating time.

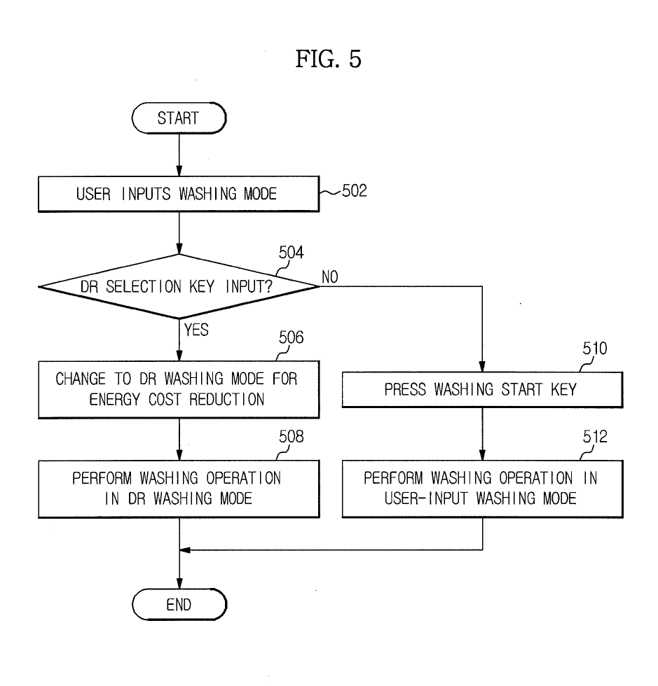

FIG. 5 is a flowchart illustrating a method for controlling a washing machine according to an embodiment of the present disclosure. Referring to FIG. 5, a user inputs a washing mode (502). Specifically, when the user puts laundry into the drum 422 shown in FIG. 4, powers on the washing machine, and then inputs a desired washing mode through the control panel 104 show in FIG. 1, the controller 402 shown in FIG. 4 receives information about the type of the washing mode input by the user or a detailed washing condition of the input washing mode. At this time, the washing mode input by the user or the washing condition is displayed on the display 106 shown in FIG. 1. Before a washing operation corresponding to the input washing mode is started by pressing the washing start key 206 shown in FIG. 2, the controller 202 confirms whether or not the DR selection key 202 is pressed (504).

If the DR selection key 202 is pressed before the washing start key 206 is pressed (504), the controller 402 changes the washing mode set by the user to a DR washing mode for reducing energy costs (506). Changing to the DR washing mode includes substituting a unit cycle having highest energy cost from among a plurality of unit cycles constructing the washing mode set by the user by a unit cycle having lower energy cost. If the user selects a washing mode involving use of hot water and presses the DR selection key 206 to select the DR washing mode, the controller 402 changes the washing mode to the DR washing mode having an increased washing time in order to provide a washing effect obtained when hot water is used while excluding a cycle using hot water which uses the heater 418 to result in an increase in energy consumption. Although the driving time of the motor 420 for rotating the drum 422 increases if the washing time increases, power consumed when the motor 420 is driven is much less than power consumed when the heater 418 is driven. Accordingly, a power consumption amount of the DR washing mode (which does not use the heater 418) is much smaller than that of the user-set washing mode using the heater 418. Changing to the DR washing mode may be implemented through various methods. Specifically, when the user-set washing mode is changed to the DR washing mode, a unit cycle having a high energy cost among unit cycles of the user-set washing mode may be replaced by a unit cycle having a low energy cost preferentially. Otherwise, only unit cycles having energy costs higher than a predetermined value among the unit cycles of the user-set washing mode may be replaced by other unit cycles having lower energy costs. In addition, the user-set washing mode may be changed to the DR washing mode such that the total energy cost of the DR washing mode does not exceed a predetermined value. Furthermore, the user-set washing mode may be selectively changed to the DR washing mode depending on energy costs of currently supplied power instead of pressing the DR selection key 202. In other words, an energy cost required to perform the user-set washing mode is compared with an energy cost when the user-set washing mode is changed to the DR washing mode and a washing operation is performed. If the difference between the energy costs is greater than a predetermined reference value, the user-set washing mode is changed to the DR washing mode. On the contrary, if the difference is less than the predetermined reference value, the user-set washing mode may not be changed to the DR washing mode and a washing operation may be performed in the user-set washing mode.

Upon change of the user-set washing mode to the DR washing mode, the controller 402 controls the washing machine in the DR washing mode and performs a washing operation (508).

If the user presses the washing start key 206 immediately after setting the washing mode without selecting the DR washing mode (NO of 504), the controller 402 receives the input of the washing start key 206 (501) and performs a washing operation in the washing mode set by the user (512).

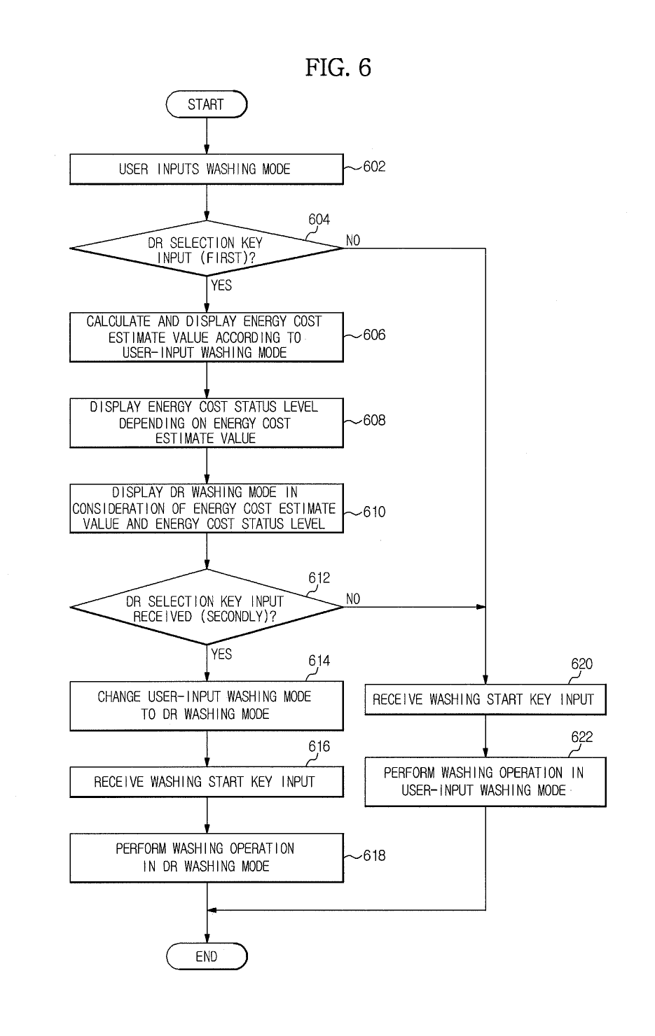

FIG. 6 is a flowchart illustrating a method for controlling the washing machine according to another embodiment of the present disclosure. Referring to FIG. 6, the user inputs a washing mode (602). Specifically, when the user puts laundry into the drum 422 of the washing machine, powers on the washing machine, and then inputs a desired washing mode through the control panel 102, the controller 402 receives information about the type of the washing mode input by the user and detailed washing conditions of the washing mode. At this time, the washing mode input by the user and the washing condition are displayed on the display 106. Before an operation corresponding to the input washing mode is started by pressing the washing start key 206, the controller 402 confirms whether or not the DR selection key 202 is pressed before the washing start key 206 is pressed (604).

If the DR selection key 202 is pressed before the washing start key 206 is pressed (YES of 604), the controller 402 changes the washing mode set by the user to the DR washing mode for energy cost reduction. The operation of changing the washing mode to the DR washing mode includes substituting a unit cycle having highest energy cost among a plurality of unit cycles constructing the washing mode set by the user by a unit cycle having lower energy cost. The controller 402 performs the following operations to allow the user to change the washing mode to the DR washing mode corresponding to a substitute washing mode for energy consumption reduction. The controller 402 calculates a power consumption estimate value of the washing mode set by the user and displays the power consumption estimate value on the display 106 (606). In addition, the controller 402 displays a load status level depending on the power consumption estimate value on the display 106 (608). Also, the controller 402 displays the DR washing mode and washing condition thereof in consideration of the power consumption estimate value and the load status level on the display 106 (610). In this manner, the power consumption estimate value (refer to 606), the load status level (refer to 608), and the DR washing mode are displayed on the display 106 in order to help the user confirm them and determine whether or not to select the DR washing mode.

If the user presses the washing start key 206 instead of the DR washing mode (NO of 604) in the operation of pressing the DR selection key 202 (604), the controller 402 receives the input of the washing start key 206 (620) and performs a washing operation in the washing mode set by the user (622).

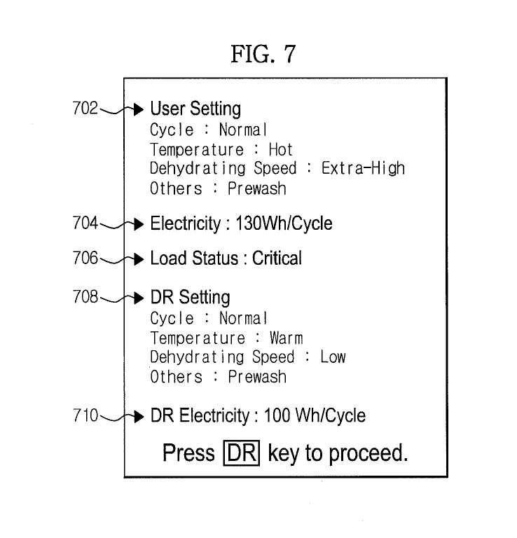

Details displayed on the display 106 when the DR washing mode is selected are explained with reference to FIG. 7. FIG. 7 shows the details displayed on the display 106 when the DR selection key 206 is pressed first according to another embodiment of the present disclosure. Referring to FIG. 7, user setting 702 represents the washing mode selected by the user in operation 602 of FIG. 6. According to user setting 702, a normal washing cycle is selected, a washing water temperature is hot, a dehydrating speed is extra-high, and pre-wash is added. Furthermore, a power consumption amount estimated when a washing operation is performed according to user setting 702 is 130 Wh/Cycle. A load status level 706 in this case is critical, which means very high energy cost. According to the DR washing mode and DR setting 708, a normal washing cycle is selected, the washing water temperature is warm, the dehydrating speed is low, and pre-wash is maintained. That is, the washing water temperature is decreased from HOT to WARM and the dehydrating speed is reduced from EXTRA-HIGH to LOW, and thus energy consumption is decreased. Here, a reduction in the washing water temperature is compensated for by increasing washing time and a reduction in the dehydrating speed is compensated for by increasing dehydrating time. A user-set power consumption amount 710 estimated when the washing operation is performed according to this changed setting is 100 Wh/cycle. That is, the power consumption amount according to DR setting 708 is reduced by 30 Wh/Cycle from the power consumption amount according to user setting 702, 130 Wh/Cycle. The user confirms the above-mentioned information through the display 106 and if the user wants to use the DR washing mode, presses the DR selection key 206 secondly to select the DR setting 708. To inform the user of this, a notice 712 such as “Press DR key to proceed” is displayed on the display 106. If the area of the display 106 is insufficient, the user setting 702, power consumption amount 704, load status level 706, DR setting 708, and DR setting estimated power consumption amount 710 may be displayed in a horizontal scroll or vertical scroll manner. Otherwise, the user setting 702, power consumption amount 704, and load status level 706 may be displayed first, and then the DR setting 708 and DR setting estimated power consumption amount 710 may be displayed after a predetermined amount of time. In this manner, the user setting 702, power consumption amount 704 according to the user setting 702, load status level 706, DR setting 708 corresponding to the load status level 706, and DR setting estimated power consumption amount 710 are displayed on the display 106 such that the user can compare energy costs in advance and select the DR washing cycle for low energy cost. The user-set washing mode can be changed to the DR washing mode according to various methods. Specifically, when the user-set washing mode is changed to the DR washing mode, a unit cycle having a high energy cost among unit cycles of the user-set washing mode may be replaced by a unit cycle having a low energy cost preferentially. Otherwise, only unit cycles having energy costs higher than a predetermined value among the unit cycles of the user-set washing mode may be replaced by other unit cycles having lower energy costs. In addition, the user-set washing mode may be changed to the DR washing mode such that the total energy cost of the DR washing mode does not exceed a predetermined value.

Referring back to FIG. 6, the controller 402 confirms whether or not the DR selection key 202 is pressed secondly (612). If the user presses the DR selection key 202 secondly in order to select the DR washing mode displayed on the display 106 (YES of 612), the controller 402 changes the user-set washing mode (702 of FIG. 7) to the DR washing mode (708 of FIG. 7) (614). This process is performed to obtain the user's approval for the DR washing mode currently displayed on the display 106. If required, the DR washing mode may be automatically executed without the user approval process. In this state, if the user presses the washing start key 206, the controller 402 receives the input of the washing start key 206 (616) and controls the washing machine in the DR washing mode to perform a washing operation (618). Notably, changing to the DR washing mode may be selectively performed depending on energy costs of currently supplied power instead of pressing the DR selection key 202. Specifically, an energy cost required to perform the user-set washing mode is compared with an energy cost required to change the user-set washing mode to the DR washing mode and perform a washing operation and if the difference between the energy costs exceeds a predetermined reference value, the user-set washing mode is changed to the DR washing mode. On the contrary, if the difference between the energy costs is less than the reference value, the user-set washing mode is not changed to the DR washing mode, and a washing operation is performed in the user-set washing mode.

In the operation (612) of confirming whether or not the DR selection key 202 is secondly pressed, if the user directly presses the washing start key 206 without selecting the DR washing mode (NO of 612), the controller 402 receives the input of the washing start key 206 (620), and then ignores DR setting and performs a washing operation in the user-set washing mode (622).

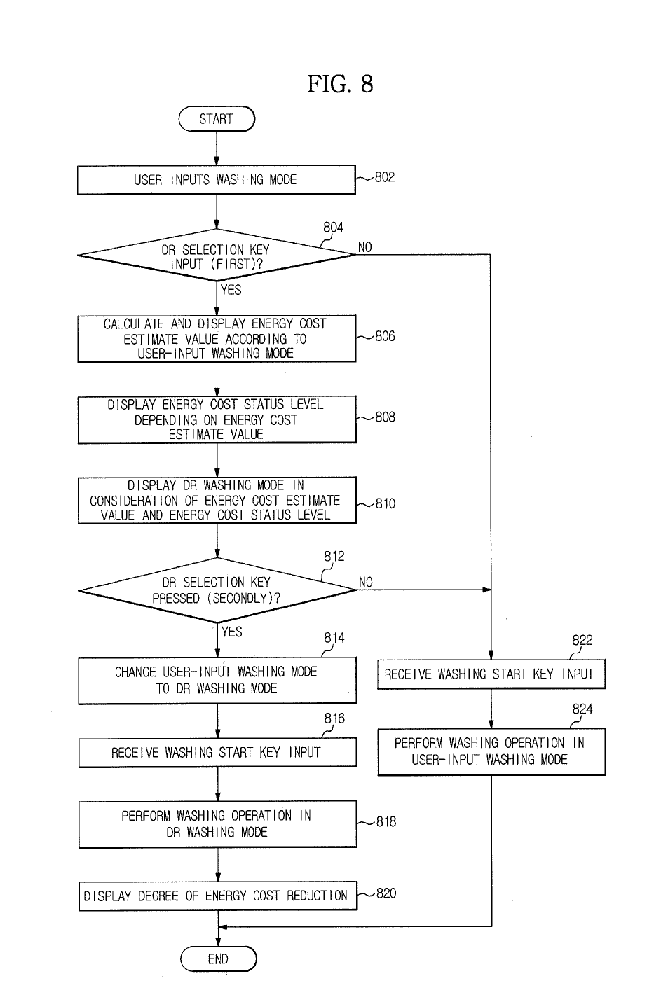

FIG. 8 is a flowchart illustrating a method for controlling a washing machine according to another embodiment of the present disclosure. Referring to FIG. 8, the user inputs a washing mode (802). Specifically, when the user puts laundry into the drum 422 of the washing machine, powers on the washing machine, and then inputs a desired washing mode through the control panel 102, the controller 402 receives information about the type of the washing mode input by the user and detailed washing conditions of the washing mode. At this time, the washing mode input by the user and the washing condition are displayed on the display 106. Before an operation corresponding to the input washing mode is started by pressing the washing start key 206, the controller 402 confirms whether or not the DR selection key 202 is pressed before the washing start key 206 is pressed (804).

If the DR selection key 202 is pressed before the washing start key 206 is pressed (YES of 804), the controller 402 changes the washing mode set by the user to the DR washing mode for energy cost reduction. The operation of changing the washing mode to the DR washing mode includes substituting a unit cycle having highest energy cost among a plurality of unit cycles constructing the washing mode set by the user by a unit cycle having lower energy cost. The controller 402 performs the following operations to allow the user to change the washing mode to the DR washing mode corresponding to a substitute washing mode for energy consumption reduction. The controller 402 calculates a power consumption estimate value of the washing mode set by the user and displays the power consumption estimate value on the display 106 (806). In addition, the controller 402 displays a load status level depending on the power consumption estimate value on the display 106 (808). Also, the controller 402 displays the DR washing mode and washing condition thereof in consideration of the power consumption estimate value and the load status level on the display 106. In this manner, the power consumption estimate value (refer to 806), the load status level (refer to 808), and the DR washing mode are displayed on the display 106 in order to help the user confirm them and determine whether or not to select the DR washing mode (810). Here, details displayed on the display 106 when the DR washing mode is selected are as described above with reference to FIG. 7. The user-set washing mode can be changed to the DR washing mode according to various methods. Specifically, when the user-set washing mode is changed to the DR washing mode, a unit cycle having a high energy cost among unit cycles of the user-set washing mode may be replaced by a unit cycle having a low energy cost preferentially. Otherwise, only unit cycles having energy costs higher than a predetermined value among the unit cycles of the user-set washing mode may be replaced by other unit cycles having lower energy costs. In addition, the user-set washing mode may be changed to the DR washing mode such that the total energy cost of the DR washing mode does not exceed a predetermined value.

If the user presses the washing start key 206 instead of the DR washing mode (NO of 804) in the operation of pressing the DR selection key 202 (804), the controller 402 receives the input of the washing start key 206 (822) and performs a washing operation in the washing mode (for example, 702 of FIG. 7) set by the user (824).

The controller 402 confirms whether or not the DR selection key 202 is pressed secondly (812). If the user presses the DR selection key 202 secondly in order to select the DR washing mode displayed on the display 106 (YES of 812), the controller 402 changes the user-set washing mode (702 of FIG. 7) to the DR washing mode (708 of FIG. 7) (814). This process is performed to obtain the user's approval for the DR washing mode currently displayed on the display 106. If required, the DR washing mode may be automatically executed without the user approval process. In this state, if the user presses the washing start key 206, the controller 402 receives the input of the washing start key 206 (816), and controls the washing machine in the DR washing mode to perform a washing operation (818). Upon completion of the washing operation in the DR washing mode, the controller 402 calculates a power consumption amount and energy costs during the washing operation and displays a degree of energy reduction on the display 106 (820). By doing so, the user can visually confirm energy reduction effect according to DR control, and thus product reliability can be remarkably improved. Notably, changing to the DR washing mode may be selectively performed depending on energy costs of currently supplied power instead of pressing the DR selection key 202. Specifically, an energy cost required to perform the user-set washing mode is compared with an energy cost required to change the user-set washing mode to the DR washing mode and perform a washing operation and if the difference between the energy costs exceeds a predetermined reference value, the user-set washing mode is changed to the DR washing mode. On the contrary, if the difference between the energy costs is less than the reference value, the user-set washing mode is not changed to the DR washing mode, and a washing operation is performed in the user-set washing mode.

In the operation (812) of confirming whether or not the DR selection key 202 is secondly pressed, if the user directly presses the washing start key 206 without selecting the DR washing mode (NO of 812), the controller 402 receives the input of the washing start key 206 (822), and then ignores DR setting and performs a washing operation in the user-set washing mode (824).

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A method for controlling a washing machine, comprising:
inputting a washing mode by a user;
replacing at least one of a plurality of unit cycles constructing the input washing mode with a new unit cycle having lower energy cost and washing effect similar to the washing effect of the input washing mode;
displaying washing operation conditions of a changed washing mode including the new unit cycle on a display; and
performing a washing operation in the changed washing mode displayed on the display.

2. The method according to claim 1, wherein the replacing of the at least one unit cycle with the new unit cycle is performed in response to a washing mode change request for energy cost reduction.

3. The method according to claim 1, wherein the replacing of the at least one unit cycle with the new unit cycle is selectively performed depending on energy costs of currently provided power.

4. The method according to claim 3, wherein the replacing of the at least one unit cycle with the new unit cycle is performed when a difference between the input washing mode and the changed washing mode exceeds a predetermined reference value.

5. The method according to claim 1, further comprising:
confirming whether or not the user approves the washing operation conditions of the changed washing mode displayed on the display; and
performing a washing operation in the changed washing mode when the user approves the washing operation conditions of the changed washing mode.

6. The method according to claim 1, further comprising displaying washing operation conditions of a washing mode prior to being changed on the display.

7. The method according to claim 6, further comprising displaying an energy cost status level of the washing mode prior to being changed on the display.

8. The method according to claim 7, further comprising displaying an energy cost estimate value of the washing mode prior to being changed and an energy cost estimate value of the changed washing mode on the display.

9. The method according to claim 8, wherein a washing operation is performed in the changed washing mode when the user approves contents displayed on the display.

10. The method according to claim 1, further comprising:
receiving current energy cost information from an energy service provider; and
calculating energy costs with reference to the received energy cost information.

11. A method for controlling a washing machine, comprising:
inputting a washing mode by a user;
calculating energy cost of each of a plurality of unit cycles constructing the input washing mode with reference to a predetermined energy cost table;
replacing at least one of the plurality of unit cycles with a new unit cycle having lower energy cost and washing effect similar to the washing effect of the input washing mode; and
performing a washing operation in a changed washing mode if washing operation conditions of the changed washing mode is approved.

12. The method according to claim 11, wherein the replacing of the at least one unit cycle with the new unit cycle is performed in response to a washing mode change request for energy cost reduction.

13. The method according to claim 11, wherein the replacing of the at least one unit cycle with the new unit cycle is selectively performed depending on energy costs of currently provided power.

14. The method according to claim 13, wherein the replacing of the at least one unit cycle with the new unit cycle is performed when a difference between the input washing mode and the changed washing mode exceeds a predetermined reference value.

15. The method according to claim 11, further comprising displaying the washing operation conditions of the changed washing mode including the new unit cycle on a display such that the user confirms the washing operation conditions of the changed washing mode, displayed on the display.

16. The method according to claim 11, wherein the energy cost table represents correlation of energy cost and washing effect of each of unit cycles constructing a washing operation as data.

17. The method according to claim 11, wherein a unit cycle having higher energy cost among the plurality of unit cycles is replaced with a new unit cycle having lower energy cost and similar washing effect.

18. The method according to claim 17, wherein only unit cycle having energy cost higher than a predetermined value is replaced with the new unit cycle.

19. A method for controlling a washing machine, comprising:
inputting a washing mode by a user;
replacing at least one of a plurality of unit cycles constructing the input washing mode with a new unit cycle having lower energy cost and washing effect similar to the washing effect of the input washing mode;
displaying washing operation conditions of a changed washing mode including the new unit cycle on a display; and
performing a washing operation in the changed washing mode when the washing operation conditions of the changed washing mode, displayed on the display, are approved,
wherein a total energy cost of the changed washing mode including the new unit cycle does not exceed a predetermined value.

20. A method for controlling a washing machine, comprising:
inputting a washing mode by a user;
replacing at least one of a plurality of unit cycles constructing the input washing mode with a new unit cycle having lower energy cost and washing effect similar to the washing effect of the input washing mode;
displaying washing operation conditions of a changed washing mode including the new unit cycle on a display;
performing a washing operation in the changed washing mode when the washing operation conditions of the changed washing mode, displayed on the display, are approved; and
displaying a degree of energy cost reduction, obtained from the washing operation performed in the changed washing mode, on the display upon completion of the washing operation in the changed washing mode.

21. A method for controlling energy cost reduction of a washing machine, comprising:
inputting a washing mode by a user;
replacing at least one of a plurality of unit cycles constructing the input washing mode with a new unit cycle having lower energy cost and washing effect similar to the washing effect of the input washing mode; and
performing a washing operation in a changed washing mode including the new unit cycle.

22. A washing machine comprising:
a control panel by which a user inputs a washing mode;
a display to display washing operation conditions of the input washing mode; and
a controller to replace at least one of a plurality of unit cycles constructing the input washing mode with a new unit cycle having lower energy cost and washing effect similar to the washing effect of the input washing mode, to display washing operation conditions of a changed washing mode including the new unit cycle on the display, and to control a washing operation in the changed washing mode when the washing operation conditions of the changed washing mode, displayed on the display, are approved.

23. The washing machine according to claim 22, wherein the controller replaces the at least one unit cycle with the new unit cycle in response to a washing mode change request for energy cost reduction.

24. The washing machine according to claim 22, wherein the controller selectively replaces the at least one unit cycle with the new unit cycle depending on energy cost of currently provided power.

25. The washing machine according to claim 24, wherein the controller replaces the at least one unit cycle with the new unit cycle when a difference between the input washing mode and the changed washing mode exceeds a predetermined reference value.

26. The washing machine according to claim 22, wherein the controller controls the display to display the washing operation conditions of the changed washing mode.

27. The washing machine according to claim 26, wherein the controller controls the display to display an energy cost status level of a washing mode prior to being changed.

28. The washing machine according to claim 27, wherein the controller controls the display to display an energy cost estimate value of the washing mode prior to being changed and an energy cost estimate value of the changed washing mode.

29. The washing machine according to claim 28, wherein the controller performs a washing operation in the changed washing mode when user approves contents displayed on the display.

30. The washing machine according to claim 22, wherein the controller receives current energy cost information from an energy service provider, and calculates energy costs with reference to the received energy cost information.

31. The washing machine according to claim 22, further comprising an indicator lamp turned on when a washing operation is performed in the changed washing mode.

32. A method for controlling energy cost reduction of a washing machine, the method comprising:
calculating energy cost of each of a plurality of unit cycles constructing at least one washing mode;
determining a substitute unit cycle having lower energy cost for each of the plurality of unit cycles;
inputting a washing mode by a user;
replacing at least one of a plurality of unit cycles constructing the input washing mode with the substitute unit cycle having lower energy cost; and
performing a washing operation in a changed washing mode including the substitute unit cycle.

33. The method according to claim 32, wherein the energy cost is energy cost per unit time.
